(19) United States
(12) Patent Application Publication
(10) Pub. No.: US 2018/0085903 A1
(43) Pub. Date: Mar. 29, 2018

(54) INSTRUCTION INDICIA ON JAW ASSEMBLY FOR PEX PRESS TOOL

(71) Applicant: MILWAUKEE ELECTRIC TOOL CORPORATION, Brookfield, WI (US)

(72) Inventors: Jeffrey M. Wackwitz, Waukesha, WI (US); Kyle J. Radovich, West Bend, WI (US); Richard P. Brault, Cedarburg, WI (US)

(21) Appl. No.: 15/715,318

(22) Filed: Sep. 26, 2017

Related U.S. Application Data
(60) Provisional application No. 62/400,423, filed on Sep. 27, 2016.

(51) Int. Cl. B25B 27/10; B25F 5/00; B25B 7/04

(52) U.S. Cl. CPC B25B 27/10; B25B 7/04; B25F 5/00

(57) ABSTRACT

A press tool for crimping a cylindrical fitting includes first and second jaws, each of which is pivotable about a pivot axis between an open position and a closed position. The press tool also includes an indicium coupled to at least one of the first jaw, the second jaw, or another component of the press tool illustrating a preferred orientation of the cylindrical fitting when positioned between the first and second jaws prior to initiating a crimping operation.

### CROSS-REFERENCE TO RELATED APPLICATIONS

This application claims priority to co-pending U.S. Provisional Patent Application No. 62/400,423 filed on Sep. 27, 2016, the entire content of which is incorporated herein by reference.

### FIELD OF THE INVENTION

The present invention relates to power tools, and more particularly to PEX (cross-linked polyethylene) crimping tools.

### BACKGROUND OF THE INVENTION

Polymer tubing is gaining popularity in residential home and commercial building construction due to the rising cost of copper pipe. One of the more common types of polymer tubing is made from cross-linked polyethylene, commonly known as PEX. Polymer tubing is typically attached to fittings using compression or crimped connectors. These connectors are compressed onto the PEX tubing using a crimping tool. Manual crimping tools, typically including a pair of handles for actuating a pair of crimper jaws by a pivoting linkage arrangement, are well known.

### SUMMARY OF THE INVENTION

The invention provides, in one aspect, a press tool for crimping a cylindrical fitting. The press tool includes first and second jaws, each of which is pivotable about a pivot axis between an open position and a closed position. The press tool also includes an indicium coupled to at least one of the first jaw, the second jaw, or another component of the press tool illustrating a preferred orientation of the cylindrical fitting when positioned between the first and second jaws prior to initiating a crimping operation.

The invention provides, in another aspect, a jaw assembly for use with a press tool to crimp a cylindrical fitting. The jaw assembly includes first and second jaws, each of which is pivotable about a pivot axis between an open position and a closed position. The jaw assembly also includes an indicium coupled to at least one of the first jaw or the second jaw illustrating a preferred orientation of the cylindrical fitting when positioned between the first and second jaws prior to initiating a crimping operation.

The invention provides, in yet another aspect, a method of using a press tool for crimping a cylindrical fitting. The method includes positioning the cylindrical fitting between first and second jaws of the press tool, each of the first and second jaws being pivotable about a pivot axis between an open position and a closed position, orienting the cylindrical fitting to a preferred orientation as shown by an indicium coupled to at least one of the first jaw, the second jaw, or another component of the press tool, and initiating a crimping operation by moving each of the first and second jaws from the open position to the closed position.

Other features and aspects of the invention will become apparent by consideration of the following detailed description and accompanying drawings.

### BRIEF DESCRIPTION OF THE DRAWINGS

FIG. 1 is a perspective view of a PEX press tool in accordance with an embodiment of the invention.

FIG. 2 is a side view of a jaw assembly for use with the press tool of FIG. 1, illustrating instruction indicia for a preferred orientation of a cylindrical fitting during a crimping operation.

FIG. 3 is a perspective view of the cylindrical fitting to be crimped using the jaw assembly of FIG. 2.

FIG. 4 is a perspective view of the cylindrical fitting of FIG. 3 during a crimping operation with the cylindrical fitting in a non-preferred orientation.

FIG. 5 is a perspective view of the cylindrical fitting of FIG. 3 during a crimping operation with the cylindrical fitting in a preferred orientation.

FIG. 6 is a side view of a PEX press crimp gauge for use with the press tool of FIG. 1.

FIG. 7 is a perspective view of the cylindrical fitting of FIG. 4 after the crimping operation has been completed with the cylindrical fitting in a non-preferred orientation.

FIG. 8 is a side view of a jaw assembly for use with a PEX press tool in accordance with another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

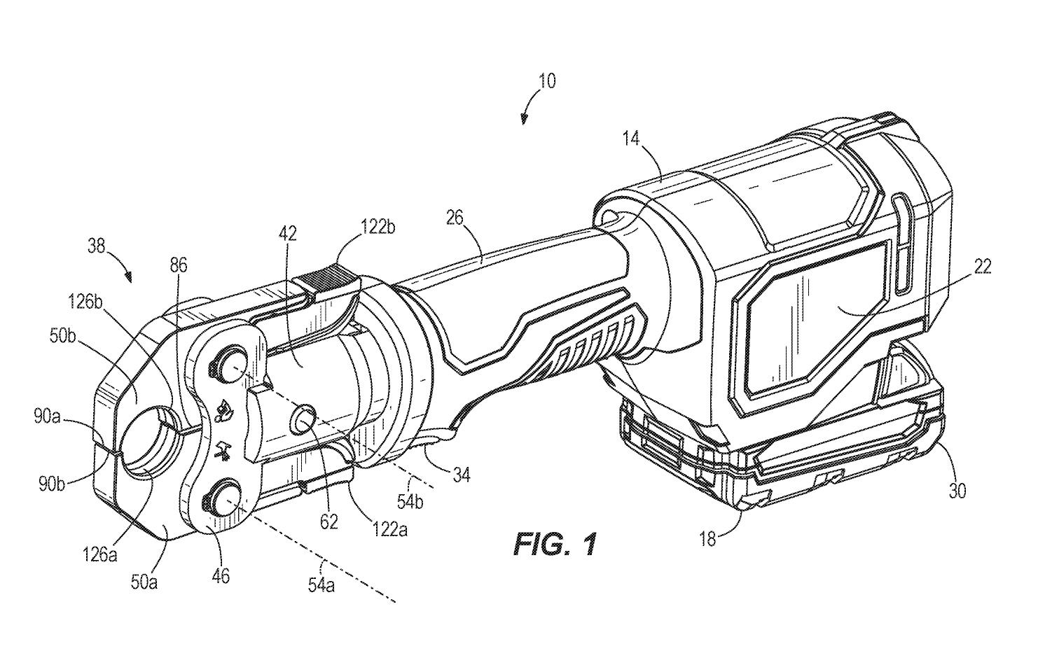

FIG. 1 illustrates a power tool, which in the illustrated embodiment is a PEX press tool 10. The press tool 10 includes an outer housing 14 having a battery support portion 18, a drive unit support portion 22, and a handle portion 26 configured to be gripped by a user during operation of the press tool 10. A battery 30 is attachable to the battery support portion 18, while a drive unit (e.g., an electric motor and a transmission, not shown) is supported within the drive unit support portion 22. A trigger 34 for initiating a crimping operation is provided on the handle portion 26.

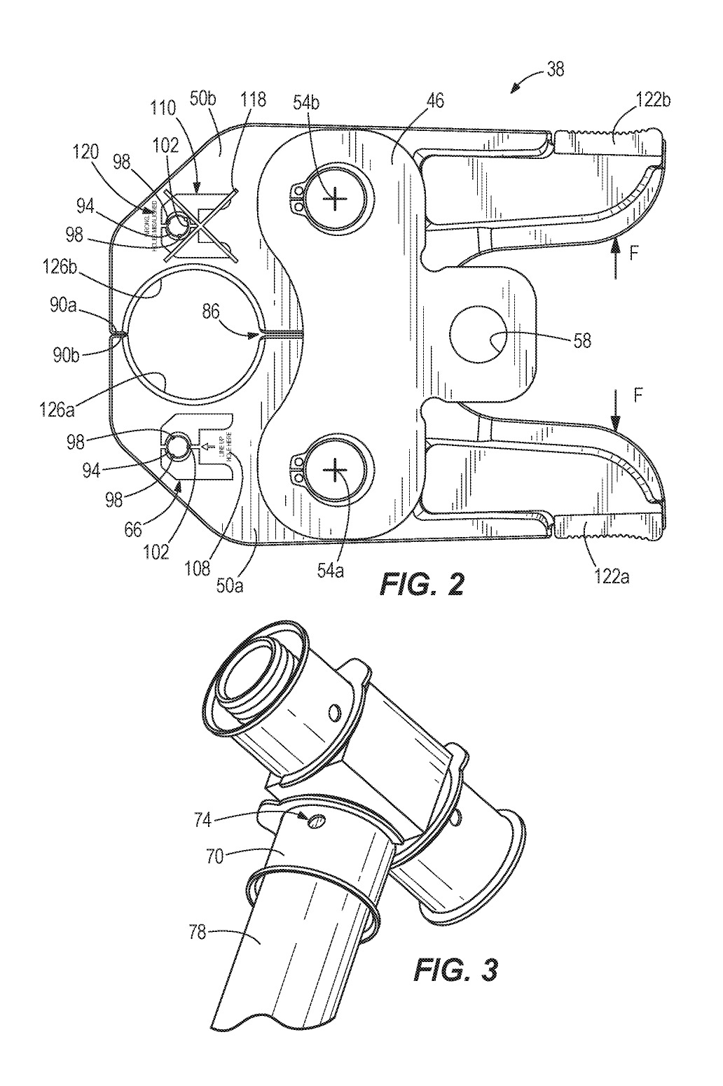

The press tool 10 also includes a jaw assembly 38 coupled to a clevis 42 which, in turn, is affixed to the handle portion 26. With reference also to FIG. 2, the jaw assembly 38 includes a bracket 46, a first jaw 50a pivotably coupled to the bracket 46 about a first pivot axis 54a, and a second jaw 50b pivotably coupled to the bracket 46 about a second pivot axis 54b parallel with the first pivot axis 54a. As such, the jaws 50a, 50b are pivotable about separate pivot axes 54a, 54b. In an alternative embodiment of the jaw assembly 38, the jaws 50a, 50b may be pivotable about a common pivot axis. With continued reference to FIG. 2, the bracket 46 also includes an aperture 58 through which a pin 62 (FIG. 1) is insertable for affixing the bracket 46 (and thus the jaws 50a, 50b) to the clevis 42. Although not shown, the jaw assembly 38 includes a biasing member, such as a leaf spring, to bias the jaws 50a, 50b toward a closed configuration.

With reference to FIG. 2, the jaw assembly 38 also includes an indicium 66 illustrating a preferred orientation of a cylindrical fitting 70 when positioned between the jaws 50a, 50b prior to initiating a crimping operation. The cylindrical fitting 70 is shown in FIG. 3, and includes multiple holes 74 (only one of which is shown) through which the end of a piece of PEX tubing 78 is viewable when the tubing 78 is fully inserted into the cylindrical fitting 70. If the tubing 78 is not visible through any of the holes 74, then it is not fully inserted within the cylindrical fitting 70. Accordingly, the holes 74 collectively function as a visual indicator to the user of the press tool 10 whether or not the tubing 78 is fully inserted within the cylindrical fitting 70. Although not all shown in FIG. 3, the cylindrical fitting 70 includes three holes 74 spaced from each other by about 120 degrees.

With reference to FIG. 2, the indicium 66 schematically illustrates two jaws, coinciding with the first and second jaws 50a, 50b, respectively, a split 86 between the jaws 50a, 50b defined by mating clamping surfaces 90a, 90b of the jaws 50a, 50b, and a schematic representation of the cylindrical fitting 70 between the jaws 50a, 50b. The cylindrical fitting 70 is schematically illustrated in the indicium 66 by a ring 94 having three pixels 98 spaced radially around the circumference of the ring 94 by about 120 degrees, coinciding with the actual position of the holes 74 in the cylindrical fitting 70 shown in FIG. 3. Specifically, the rearward-most pixel 102 in the indicium 66 (using a frame of reference where the front of the press tool 10 coincides with the jaw assembly 38 and the rear of the press tool 10 coincides with the drive unit support portion 22) is shown aligned with the split 86, which naturally positions the other two holes 74 in the cylindrical fitting 70 as a result of the 120-degree spacing between the holes 74 (as shown by the remaining two pixels 98 in the indicium 66) at a location misaligned with the split 86. The indicium 66 also includes a textual instruction 108 to the user to align the rearward-most hole 74 in the cylindrical fitting 70 with the split 86 in the jaw assembly 38. Although the indicium 66 is coupled to the first jaw 50a, the indicium 66 may alternatively be located on the bracket 46 or another component of the press tool 10 (e.g., the outer housing 14 or clevis 42, for example). Moreover, the indicium 66 may be coupled to the first jaw 50a, the bracket 46, or another component of the press tool 10 using, for example, a printing process or an engraving process. Alternatively, the indicium 66 may be formed on an adhesive-backed label and applied to the first jaw 50a, the bracket 46, or another component of the press tool 10.

With reference to FIG. 2, the jaw assembly 38 also includes another indicium 110 illustrating a non-preferred orientation of a cylindrical fitting 70 when positioned between the jaws 50a, 50b prior to initiating a crimping operation. The indicium 110 is substantially similar to the indicium 66 illustrating the preferred orientation of the cylindrical fitting 70, except the schematic representation of the cylindrical fitting 70 is shown with the rearward-most pixel (102) in the indicium 110 misaligned with the split 86, which naturally positions the forward-most of the remaining two holes 74 in the cylindrical fitting 70 in alignment with or proximate the split 86. The indicium 110 also includes an “X” as a visual indicator 118 not to orient the cylindrical fitting 70 within the jaw assembly 38 in this manner. Further, the indicium 110 includes a textual instruction 120 to the user not to align the holes 74 in the cylindrical fitting 70 relative to the split 86 in the manner shown. Although the indicium 110 is coupled to the second jaw 50b, the indicium 110 may alternatively be located on the bracket 46 or another component of the press tool 10 (e.g., the outer housing 14 or clevis 42, for example). Moreover, the indicium 110 may be coupled to the second jaw 50b, the bracket 46, or another component of the press tool 10 using, for example, a printing process or an engraving process. Alternatively, the indicium 110 may be formed on an adhesive-backed label and applied to the second jaw 50b, the bracket 46, or another component of the press tool 10. In a further embodiment of the press tool 10, the indicium 110 may be omitted in favor of using only the indicium 66.

In operation of the press tool 10, the user may position the cylindrical fitting 70 between the first and second jaws 50a, 50b by pressing an arm portion 122a, 122b of the respective jaws 50a, 50b, against the bias of the biasing member, thereby placing the jaws 50a, 50b in an open configuration in which respective crimping portions 126a, 126b of the jaws 50a, 50b are spaced from each other a sufficient distance to position the cylindrical fitting 70 between the crimping portions 126a, 126b of the jaws 50a, 50b. Prior to the user releasing the arm portions 122a, 122b of the jaws 50a, 50b, the cylindrical fitting 70 should be rotated to the preferred orientation as shown in the indicium 66 with the rearward-most hole 74 (shown schematically by the rearward-most pixel 102 in the indicium 66) in alignment with the split 86. Alternatively, the user may first release the arm portions 122a, 122b of the respective jaws 50a, 50b, which are biased to a closed configuration by the biasing member, thereby applying a light clamping force on the cylindrical fitting 70. Thereafter, the user may rotate the cylindrical fitting 70 to the preferred orientation as shown in the indicium 66 with the rearward-most hole 74 in alignment with the split 86.

Once the cylindrical fitting 70 is positioned within the jaw assembly 38 in the preferred orientation, the user may initiate a crimping operation by depressing the trigger 34, which activates the drive unit to apply a force F (FIG. 2) to the arm portions 122a, 122b of the respective jaws 50a, 50b, causing the crimping portions 126a, 126b of the jaws 50a, 50b to move toward each other to crimp the cylindrical fitting 70. Presuming the cylindrical fitting 70 is in the preferred orientation (as shown in FIG. 5), none of the forward-most holes 74 in the fitting 70 are aligned with the split 86, thus preventing flashing on the portions of the cylindrical fitting 70 containing the holes 74.

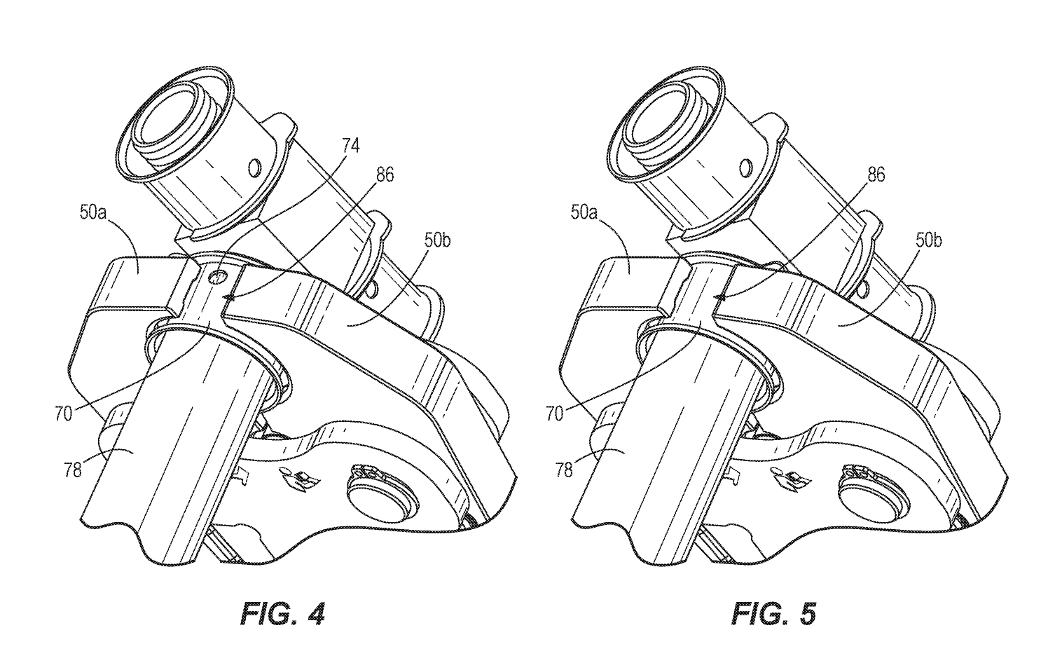

If the cylindrical fitting 70 is in the non-preferred orientation (thus aligning the forward-most hole 74 in the cylindrical fitting 70 with the split 86 as shown in FIG. 4), flashing 138 (FIG. 7) would occur on the portion of the cylindrical fitting 70 containing the forward-most hole 74 during a crimping operation, which may compromise the seal formed between the tubing 78 and the cylindrical fitting 70. More specifically, such flashing 138 would result from a longitudinal portion of the cylindrical fitting 70 being folded into halves along a fold line, with the two halves being pressed together during the crimping operation. If the fold line intersects the forward-most hole 74 of the cylindrical fitting 70, a split 142 would be created through the folded halves coinciding with the location of the forward-most hole 74, potentially compromising the seal formed between the tubing 78 and the cylindrical fitting 70.

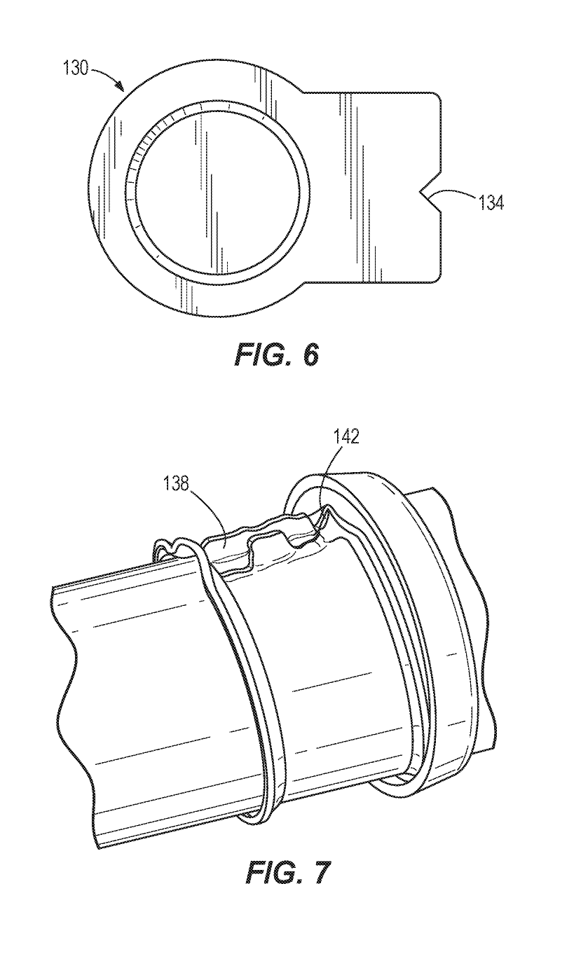

Referring to FIG. 6, a PEX press crimp gauge 130 is shown for determining the sufficiency of a crimp applied to the cylindrical fitting 70. The gauge 130 is used after the cylindrical fitting 70 has been crimped to measure any flashing formed on the cylindrical fitting 70 caused by the crimping operation. Specifically, the gauge 130 includes a V-shaped groove 134 into which any flashing formed on the cylindrical fitting 70 may protrude when the gauge 130 is positioned on the outer circumferential periphery of the crimped cylindrical fitting 70. If in this situation the flashing touches the bottom of the groove 134, the crimped cylindrical fitting 70 is rejected. Otherwise, if any flashing formed on the cylindrical fitting 70 does not contact the bottom of the groove 134 when the gauge 130 is positioned on the outer circumferential periphery of the crimped cylindrical fitting 70, the crimped cylindrical fitting 70 passes inspection.

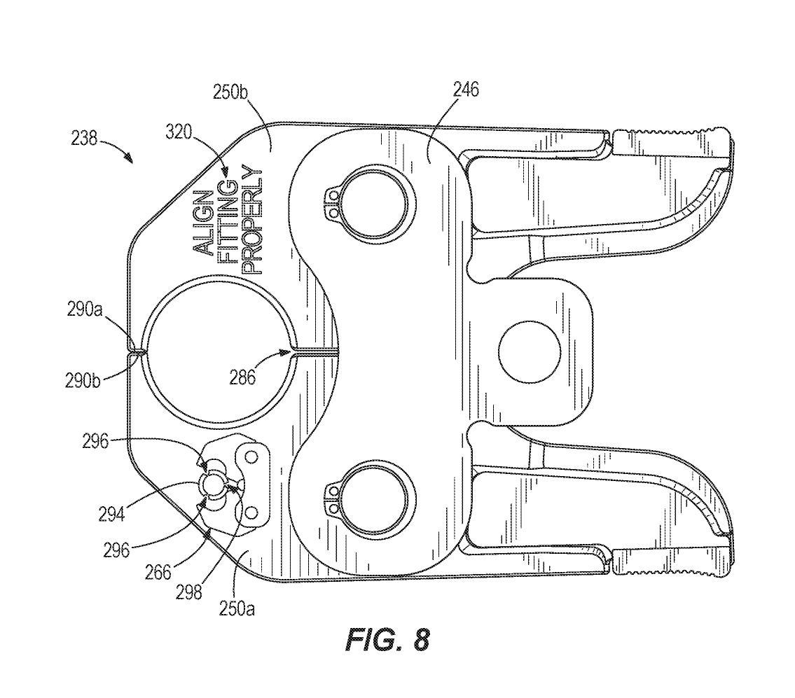

FIG. 8 illustrates another embodiment of a jaw assembly 238 for use with the press tool 10 of FIG. 1, with like features being shown with like reference numerals plus “200.” The indicium 266 schematically illustrates two jaws, coinciding with the first and second jaws 250a, 250b, respectively, a split 286 between the jaws 250a, 250b defined by mating clamping surfaces 290a, 290b of the jaws 250a, 250b, and a schematic representation of the cylindrical fitting 70 between the jaws 250a, 250b. The cylindrical fitting 70 is schematically illustrated in the indicium 266 by a ring 294 having three apertures 296 spaced radially around the circumference of the ring 294 by about 120 degrees, coinciding with the actual position of the holes 74 in the cylindrical fitting 70 shown in FIG. 3. Specifically, the rearward-most aperture 298 in the indicium 266 (using a frame of reference where the front of the press tool 10 coincides with the drive unit support portion 22) is shown aligned with the split 286, which naturally positions the other two holes 74 of the cylindrical fitting 70 as a result of the 120-degree spacing between the holes 74 (as shown by the remaining two apertures 296 in the indicium 266) at a location misaligned with the split 286. Although the indicium 266 is coupled to the first jaw 250a, the indicium 266 may alternatively be located on the bracket 246 or another component of the press tool 10 (e.g., the outer housing 14 or clevis 42, for example). Moreover, the indicium 266 may be coupled to the first jaw 250a, the bracket 246, or another component of the press tool 10 using, for example, a printing process or an engraving process. Alternatively, the indicium 266 may be formed on an adhesive-backed label and applied to the first jaw 250a, the bracket 246, or another component of the press tool 10.

With continued reference to FIG. 8, the jaw assembly 238 also includes a textual instruction 320 to the user to align the cylindrical fitting 70 properly before a crimping operation is performed with the press tool 10. Although the textual instruction 320 is coupled to the second jaw 250b, the textual instruction 320 may alternatively be located on the bracket 246 or another component of the press tool 10 (e.g., the outer housing 14 or clevis 42, for example). Moreover, the textual instruction 320 may be coupled to the first jaw 250a, the bracket 246, or another component of the press tool 10 using, for example, a printing process or an engraving process. Alternatively, the textual instruction 320 may be formed on an adhesive-backed label and applied to the second jaw 250b, the bracket 246, or another component of the press tool 10. In a further embodiment of the press tool 10, the textual instruction 320 may be omitted in favor of using only the indicium 266.

Various features of the invention are set forth in the following claims.

What is claimed is:

1. A press tool for crimping a cylindrical fitting, the press tool comprising:
first and second jaws, each of which is pivotable about a pivot axis between an open position and a closed position; and
an indicium coupled to at least one of the first jaw, the second jaw, or another component of the press tool illustrating a preferred orientation of the cylindrical fitting when positioned between the first and second jaws prior to initiating a crimping operation.

2. The press tool of claim 1, wherein the indicium is a first indicium, and wherein the press tool further comprises a second indicium coupled to at least one of the first jaw, the second jaw, or another component of the press tool.

3. The press tool of claim 2, wherein the second indicium is a textual instruction instructing a user to properly align the cylindrical fitting prior to initiating the crimping operation.

4. The press tool of claim 3, wherein the first indicium is coupled to the first jaw and the second indicium is coupled to the second jaw.

5. The press tool of claim 1, wherein the indicium is coupled to the first jaw.

6. The press tool of claim 5, wherein the indicium includes respective images of a first jaw, a second jaw, and a cylindrical fitting.

7. The press tool of claim 6, wherein the cylindrical fitting of the indicium includes a ring having three apertures spaced about a perimeter thereof coinciding with three apertures in the cylindrical fitting positioned between the first and second jaws.

8. The press tool of claim 7, wherein a rearward-most aperture in the ring is aligned with a split between the first and second jaws of the indicium.

9. The press tool of claim 1, wherein the indicium is coupled to at least one of the first jaw, the second jaw, or another component of the press tool using a printing process or an engraving process.

10. The press tool of claim 1, wherein the indicium is formed on an adhesive-backed label and coupled to at least one of the first jaw, the second jaw, or another component of the press tool.

11. A jaw assembly for use with a press tool to crimp a cylindrical fitting, the jaw assembly comprising:
first and second jaws, each of which is pivotable about a pivot axis between an open position and a closed position; and
an indicium coupled to at least one of the first jaw or the second jaw illustrating a preferred orientation of the cylindrical fitting when positioned between the first and second jaws prior to initiating a crimping operation.

12. The jaw assembly of claim 11, wherein the indicium is a first indicium, and wherein the press tool further comprises a second indicium coupled to at least one of the first jaw or the second jaw.

13. The jaw assembly of claim 12, wherein the second indicium illustrates a non-preferred orientation of the cylindrical fitting when positioned between the first and second jaws prior to initiating the crimping operation.

14. The jaw assembly of claim 12, wherein the second indicium is a textual instruction instructing a user to properly align the cylindrical fitting prior to initiating the crimping operation.

15. The jaw assembly of claim 11, wherein the indicium includes respective images of a first jaw, a second jaw, and a cylindrical fitting.

16. The jaw assembly of claim 15, wherein the cylindrical fitting of the indicium includes a ring having three apertures spaced about a perimeter thereof coinciding with three apertures in the cylindrical fitting positioned between the first and second jaws.

17. The jaw assembly of claim 16, wherein a rearward-most aperture in the ring is aligned with a split between the first and second jaws of the indicium.

18. A method of using a press tool for crimping a cylindrical fitting, the method comprising:
positioning the cylindrical fitting between first and second jaws of the press tool, each of the first and second jaws being pivotable about a pivot axis between an open position and a closed position;
orienting the cylindrical fitting to a preferred orientation as shown by an indicium coupled to at least one of the first jaw, the second jaw, or another component of the press tool; and
initiating a crimping operation by moving each of the first and second jaws from the open position to the closed position.

19. The method of claim 18, further comprising:
positioning the cylindrical fitting onto a piece of PEX tubing; and
aligning a rearward-most aperture in the cylindrical fitting with a split between the first and second jaws, in accordance with the preferred orientation as shown by the indicium, prior to initiating the crimping operation.

20. The method of claim 18, further comprising measuring flashing on the cylindrical fitting using a crimp gauge to determine the sufficiency of the crimping operation.
